(19) United States
(12) Patent Application Publication
(10) Pub. No.: US 2010/0330436 A1
(43) Pub. Date: Dec. 30, 2010

(54) ZINC AIR CELL ADAPTABLE TO CELLULAR PHONE AND METHOD FOR MANUFACTURING THE SAME

(76) Inventors: Byung Hoon Ryou, Seoul (KR); Jae Kyung Kong, Seoul (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/602,084

(22) PCT Filed: May 21, 2008
(86) PCT No.: PCT/KR08/02835

§ 371 Date: May 28, 2010

(30) Foreign Application Priority Data
Jun. 7, 2007 (KR) 10-2007-0055475

(51) Int. Cl. H01M 12/06; H01M 12/00

(52) U.S. Cl. 429/405; 156/60; 156/73.1

(57) ABSTRACT

The present invention relates to a method of fabricating a zinc-air cell and a zinc-air cell fabricated using the same. The zinc-air cell includes a cup adapted to function as a sealant of the cell, a film adapted to function as an anode of the cell and bonded on the cup, wherein the film has a first surface with a hydrophobic property and a second surface with ion permeability, and the second surface comes in contact with the cup, and a zinc gel adapted to function as a cathode of the cell and filled between the cup and the sealant. The method of fabricating a zinc-air cell includes preparing a cup having a central portion of a downward depressed shape and functioning as a sealant of the cell, bonding a film adapted to function as an anode of the cell on the cup, and filling a zinc gel, which functions as a cathode of the cell, in a space between the cup and the sealant.

### TECHNICAL FIELD

The present invention relates to a method of fabricating a zinc-air cell and a zinc-air cell fabricated using the same, and more particularly, to a zinc-air cell of a rectangular parallelepiped shape, which is applicable to, for example, a cellular phone battery.

### BACKGROUND ART

As conventional means for supplying power to electronic devices, a battery was widely used. The primary cells, such as manganese cells, alkaline manganese cells, and zinc-air cells, and the secondary cells, such as nickel cadmium (Ni—Cd) cells, nickel hydride (Ni—H) cells, and lithium ion cells, were used as the conventional cells. Of them, the zinc-air cell is advantageous in that it provides a relatively high voltage of 1.4 V, and has a high energy density and a great discharge capacity. Further, the zinc-air cell has an almost constant discharge characteristic until the discharge of the cell is completed and has therefore been considered to be able to replace the mercury cell whose use is prohibited since it contains heavy metal.

FIG. 1 is a sectional view of a conventional button shape zinc-air cell. Referring to FIG. 1, the conventional button shape zinc-air cell includes a membrane 10 as an anode, and a zinc gel 16 as a cathode. A separator 12 is intervened between the membrane 10 and the zinc gel 16. Further, the membrane 10 and the zinc gel 16 are accommodated within a conductive anode can 18 and a cathode can 20, respectively, thus constituting a cell.

The membrane 10 is a permeable membrane including water molecules and comes in contact with oxygen in the air, thus generating hydration ion OH⁻. This reaction can be represented by the following Chemical Formula.

ChemistryFigure 1

O₂+2H₂O+4e⁻ [symbol] 4OH⁻ [Chem. 1]

In the above reaction, electrons are supplied through the anode can 18. Material of the membrane generally includes carbon, but may employ a proper material according to a necessary voltage or an application field.

Since oxygen is required in the reaction in the anode as described above, the anode must have a path which can come in contact with the air, and therefore air holes 14 are formed at the bottom of the anode can 18. The air holes 14 are sealed when the cell is not used so as to prohibit the reaction in the anode.

Hydration ions generated by the above chemical reaction are transferred to the zinc gel 16, that is, the cathode through the separator 12. The separator 12 has permeability with respect to hydration ions and functions to prevent the leakage of the zinc gel 16 and insulate the zinc gel 16 and the membrane 10 from each other.

The zinc gel 16 includes zinc powder as a major component and has additives and electrolyte mixed therein. Typically, the electrolyte includes potassium hydroxide (KOH) aqueous solution. When the hydration ions are transferred to the zinc gel 16, the zinc powder is oxidized through a reaction with the hydration ions. This reaction can be represented by the following Chemical Formula.

ChemistryFigure 2

Zn+2OH⁻ [symbol] Zn(OH)₂+2e⁻

Zn+2OH⁻ [symbol] ZnO+H₂O+2e⁻ [Chem. 2]

Electrons are generated in the cathode through this reaction, and the generated electrons are transferred through the cathode can 20. Through this chemical reaction, voltage of a maximum of 1.65V can be generated theoretically.

This zinc-air cell has advantageous properties in terms of voltage, the energy density, the discharge capacity, a discharge characteristic, etc. However, use of the conventional zinc-air cell is limited to special fields such as hearing aids and cameras. In particular, sealing using the anode can 18 and the cathode can 20 for transferring electrons, generated from the cathode, to the anode is indispensable. Thus, the conventional zinc-air cell has been only sold as a button shape cell, but has not been fabricated as a shape that can be used for mobile terminal or cellular phone battery, preferably, a rectangular parallelepiped shape.

Therefore, there is a need for a method of fabricating the zinc-air cell, having the above advantageous properties, in a shape that can be used for cellular phone battery, etc. That is, it is necessary to develop a method of obviating sealing using the anode can 18 and the cathode can 20, that is, the problem which was indispensable to transfer electrons between the anode and the cathode, but made the conventional zinc-air cell fabricated only in the button shape.

### DISCLOSURE OF INVENTION

### Technical Problem

Accordingly, the present invention has been made in view of the above problems occurring in the prior art, and an object of the present invention is to provide a method of fabricating a zinc-air cell in a shape that can be used in a cellular phone battery, etc., and a zinc-air cell fabricated using the method, in which, in the zinc-air cell, a film adapted to function as the anode is stacked on a cup adapted to function as a sealant and a zinc gel adapted to function as the cathode is filled between the cup and the film, thus efficiently sealing the zinc-air cell, and a terminal is used as an electron migration path, thereby obviating sealing using the anode can 18 and the cathode can 20 when fabricating the zinc-air cell.

### Technical Solution

To achieve the above object, in accordance with an embodiment of the present invention, there is provided a zinc-air cell, including a cup adapted to function as a sealant of the cell, a film adapted to function as an anode of the cell and bonded on the cup, wherein the film has a first surface with a hydrophobic property and a second surface with ion permeability, and the second surface comes in contact with the cup, and a zinc gel adapted to function as a cathode of the cell and filled between the cup and the sealant.

Preferably, the zinc-air cell can further include a cathode terminal drawn from the zinc gel to the outside of the cell and transporting electrons, which are generated by a chemical reaction in the zinc gel, and an anode terminal for supplying electrons from the outside to the film such that a chemical reaction can be generated in the film adapted to function as the anode.

Here, the first surface is preferably formed from Teflon material, and the second surface is formed of polypropylene material.

Further, the cup is preferably formed from polypropylene material.

Meanwhile, the cup can be preferably formed from the same material as that of the second surface of the film.

The film can have a multi-layered structure including a metal mesh, and the anode terminal can be formed by removing a layer on a top of the metal mesh in one end of the film and exposing the metal mesh.

Further, preferably, the cathode terminal has a shape curved in an S shape or C shape.

To achieve the above object, in accordance with an embodiment of the present invention, there is provided a method of fabricating a zinc-air cell, including the steps of preparing a cup having a central portion of a downward depressed shape and functioning as a sealant of the cell, bonding a film adapted to function as an anode of the cell on the cup, wherein the film has a first surface with a hydrophobic property and a second surface with ion permeability, and the second surface comes in contact with the cup, and filling a zinc gel, which functions as a cathode of the cell, in a space between the cup and the sealant.

Preferably, the method further includes the steps of inserting a cathode terminal for carrying electrons, which are generated in the zinc gel, into the zinc gel and drawing the cathode terminal outside the cell, and forming an anode terminal for supplying electrons to the film.

Preferably, the step of forming the anode terminal includes removing a layer on a top of the metal mesh in one end of the film and exposing the metal mesh.

The bonding step is preferably performed using bonding employing heat fusion, ultrasonic fusion or a bonding agent.

Meanwhile, the method can further include the step of curving edges of the cup in a shape that can surround the film so that the film is depressed in the edges of the cup.

Here, the cup is formed of the same material as that of the second surface of the film.

Further, preferably, the method further includes the step of curving the cathode terminal in an S shape or C shape.

### ADVANTAGEOUS EFFECTS

In accordance with the present invention, a zinc-air cell can be implemented in a desired shape, for example, a rectangular parallelepiped shape applicable to a cellular phone battery.

### BRIEF DESCRIPTION OF THE DRAWINGS

Further objects and advantages of the invention can be more fully understood from the following detailed description taken in conjunction with the accompanying drawings in which:

FIG. 1 is a sectional view of a conventional button shape zinc-air cell;

FIG. 2 is a sectional view of a zinc-air cell in accordance with an embodiment of the present invention;

FIG. 3 is a sectional view of a zinc-air cell in accordance with another embodiment of the present invention;

FIG. 4 is a sectional view of a film adapted to function as the anode of the zinc-air cell; and

FIG. 5 is a perspective view of the zinc-air cell in accordance with the present invention.

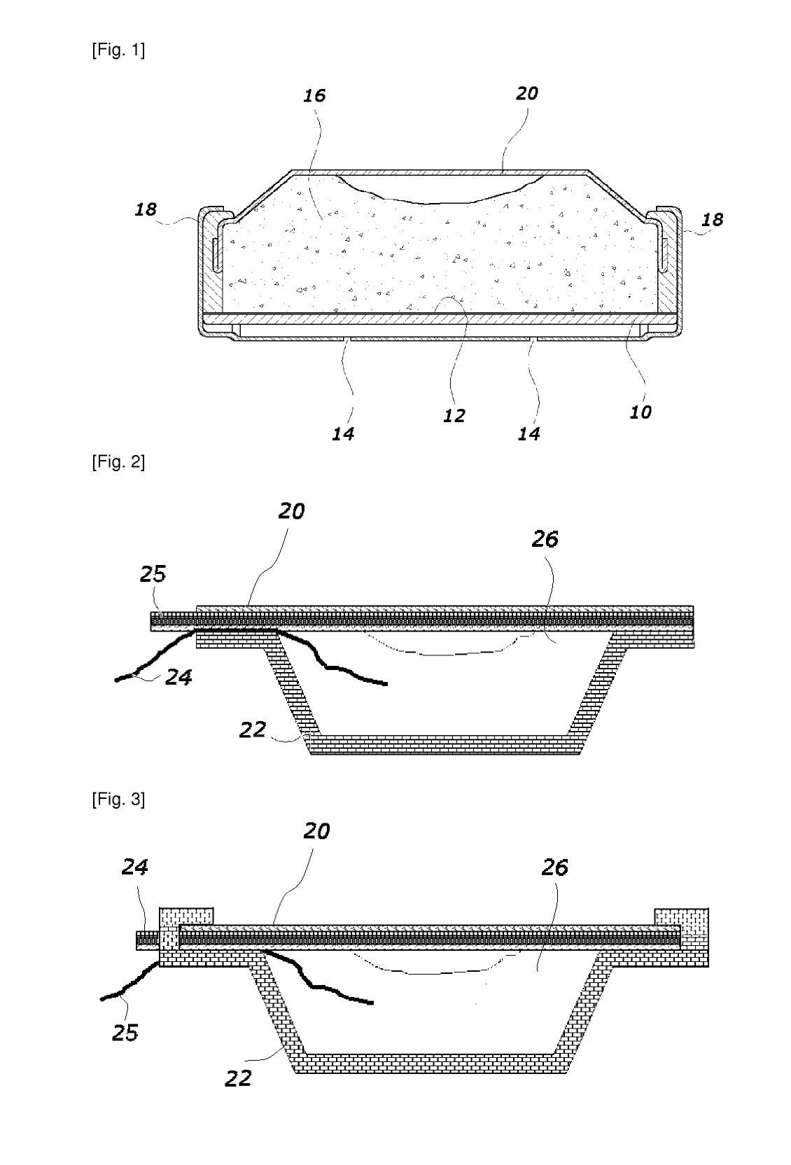

### BEST MODE FOR CARRYING OUT THE INVENTION

The present invention will now be described in detail in connection with an embodiment with reference to the accompanying drawings.

FIG. 2 is a sectional view of a zinc-air cell in accordance with an embodiment of the present invention. The zinc-air cell includes a cup 22 functioning as a sealant, a film 20 which is fused or bonded on the cup 22 and functions an air anode generating the reaction of the Chemical Formula 1, and a zinc gel 26 which is filled between the cup 22 and the film 20 and functions as a cathode generating the reaction of the Chemical Formula 2.

The cup 22 has a central portion of a downward depressed shape or a rectangle plate shape. The depressed degree of the cup 22 can be properly controlled in consideration of the amount of the zinc gel 26 filled between the cup 22 and the film 20.

The zinc-air cell further includes a cathode terminal 24 drawn from the zinc gel 26 to the outside of the cell, and an anode terminal 25 extending from the film 20. The film 20 is fabricated in a shape that can form the anode terminal 25 as shown in FIGS. 2 and 5, and the anode terminal 25 is described later on. The cathode terminal 24 transports electrons, which are generated by the reaction of the Chemical Formula 2, from a portion in which the zinc gel 26 is filled to the outside of the cell, and the anode terminal transports electrons from the outside of the cell to the film 20 so that the reaction of the Chemical Formula 1 is generated in the film 20. In the zinc-air cell, typically, the zinc gel 26 cannot be fully filled in space between the cup 22 and the film 20. For this reason, there is a possibility that the cathode terminal 24 may not come in touch with the zinc gel 26 having fluidity. Therefore, it is preferred that the cathode terminal 24 inserted into the zinc-air cell be curved in an S shape or C shape and always come in contact with the zinc gel 26 irrespective of which state is the zinc gel 26 with fluidity is placed.

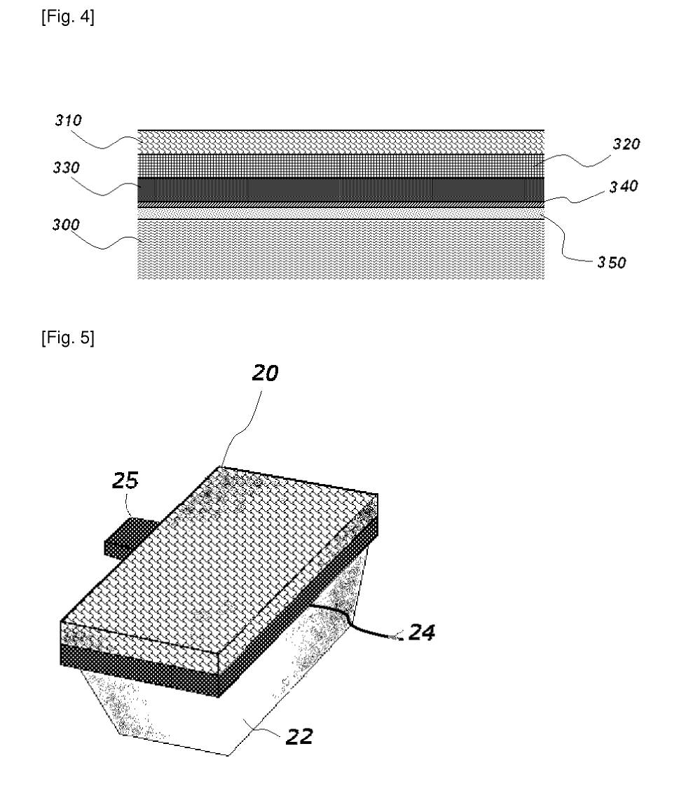

In the zinc-air cell in accordance with the present invention, the film 20 functioning as the anode employs a film as shown in FIG. 4. The anode film includes a separator 350 for separating the zinc gel 300 from other elements, a catalyst layer 330 that generates the reaction of the Chemical Formula 1 through a reaction with oxygen in the air, a metal mesh 320, and a hydrophobic membrane 310 disposed to extend the lifespan of the cell by preventing adsorption of carbon dioxide. The catalyst layer 330 and the separator 350 are bonded together by a bonding agent 340. In general, the separator 350 employs material having ion permeability, for example, polypropylene material, and the hydrophobic membrane 310 employs Teflon material. Further, the catalyst layer 330 is generally carbon material.

In the film shown in FIG. 4, the hydrophobic membrane 310 is very difficult to adhere to other materials due to an inert characteristic, whereas the separator 350 has a characteristic that it can easily adhere to other materials. Thus, if the separator 350 of the film 20 is brought in contact with the cup 22 as shown in FIG. 2 using this characteristic, the bonding effect can be increased. The bonding method may employ heat fusion, ultrasonic fusion or a bonding method. This cup 22 can use the same material as that of the separator 350, that is, polypropylene, but not limited thereto. For example, the cup 22 can employ polymer material, such as plastic or resin, which is appropriate for sealing in consideration of material of the separator 350.

Further, in the film shown in FIG. 4, the metal mesh 320 is a conductive material and can become a migration path of electrons that are generated by a chemical reaction occurring in the film 20. Therefore, in one end of the film 20 fabricated to have a proper shape so that the anode terminal 25 can be formed as shown in FIGS. 2 and 4, the hydrophobic membrane 310 is removed so as to expose the metal mesh 320. Thus, the exposed metal mesh 320 can be utilized as the anode terminal 25.

Meanwhile, the zinc-air cell can further include a casing (not shown) to surround the cup 22 and the film 20 formed on the cup 22. In this case, apertures for passing the air have to be formed in the casing in order for the film 20 to come in contact with the air and therefore generate the chemical reaction of the Chemical Formula 1. Further, the casing has to be formed such that the cathode terminal 24 and the anode terminal 25 are drawn to the outside.

Next, the zinc-air cell in accordance with another embodiment of the present invention is described with reference to FIG. 3. In the zinc-air cell, the edges of the cup 22 are formed wide enough to surround the film 20. This configuration further enhances adhesive force between the cup 22 and the film. In the zinc-air cell shown in FIG. 3, the entire configurations other than the shape of the cup 22 are substantially the same as that of an embodiment of the present invention, which has been described with reference to FIG. 2, and description thereof is omitted. Further, although it is shown in FIG. 3 that the cup 22 is formed to surround the film 20, the area of the film 20 may be formed greater than the plan area of the cup 22 such that the edges of the film 20 are curved and surround the cup 22.

As described above, in the zinc-air cell in accordance with the present invention, the film 20 is stacked on the rectangle plate-shaped cup 22 having the downward depressed central portion. Accordingly, the zinc-air cell can be fully sealed, thereby realizing efficient and convenient sealing. The conventional zinc-air cell could be fabricated in a specific shape due to the difficulty of sealing. However, the present invention has solved the difficulty of such sealing and therefore enables fabrication of a zinc-air cell having a desired shape.

Meanwhile, the zinc-air cell in accordance with the present invention employs the cathode terminal 24 and the anode terminal 25 as an electron migration path required for a chemical reaction in the anode and the cathode. Thus, the present invention excludes the anode can 18 and the cathode can 20, which were used as the electron migration path in the conventional zinc-air cell, so that an overall shape of the cell can be implemented as a rectangular parallelepiped shape applicable to a cellular phone battery.

A method of fabricating the zinc-air cell in accordance with an embodiment of the present invention is described below with reference to FIG. 2. First, the cup 22 functioning as the sealant of the zinc-air cell is prepared. The cup 22 can have a shape whose central portion is depressed or a rectangle plate shape. In this case, the zinc gel 26 functioning as the cathode of the cell will be filled in the downward depressed portion of the cup 22 and, therefore, the cup 22 is formed in consideration of the amount of the zinc gel 26 to be filled.

Next, the zinc gel 26 functioning as the cathode of the cell is filled in the downward depressed portion of the cup 22. The amount of the zinc gel 26 is controlled in such a way not to fully fill space created when the film 20 is bonded on the cup 22.

The cathode terminal 24 is then inserted into the zinc gel 26, and the film 20 is bonded on the cup 22. At this time, the hydrophobic membrane 310 (refer to FIG. 4) of the film 20 is placed on the upper side and the separator 350 is placed on the lower side, that is, a position coming in contact with the cup 22, and the cathode terminal 24 is drawn from the zinc gel 26 to the outside through the contact portion of the cup 22 and the film 20. Further, in order to remove a possibility that the cathode terminal 24 may not come in contact with the zinc gel 26 with fluidity as described above, the cathode terminal 24 is preferably curved in an S shape or C shape. A bonding method using heat fusion, ultrasonic fusion or a bonding agent can be used in order to adhere the cup 22 and the separator 350 of the film 20 together. Material of the cup 22 may be the same as that of the separator 350 placed on the lower side of the film 20, but not limited thereto. For example, it is preferred that the material of the cup 22 be material that can be easily bonded in consideration of material of the separator 350. If polymer material such as polypropylene is used, a sealing effect can be further increased due to heat or ultrasonic fusion.

More specifically, heat fusion is a method of performing bonding by heating the cup 22 using a heater. Further, fusion using ultrasonic waves is a method of fabricating a jig of a proper shape in order to fix the cup 22 and the film 20 and performing fusion using an ultrasonic fusion apparatus. Meanwhile, the bonding method using a bonding agent is a method of coating a bonding agent on the edges of the cup 22, that is, a portion that will be bonded with the film 20 and then adhering the film 20. An adhesive tape may be used instead of the bonding agent.

In the bonding of the cup 22 and the film 20, a variety of bonding methods other than the above methods can be used, and it is considered that those having ordinary skill in the art may select a known bonding method and apply the selected method to the present invention.

Meanwhile, in the case in which the edges of the cup 22 are wide as shown in FIG. 3 in fabricating the zinc-air cell, a process of curving the edges of the cup 22 so that the film 20 is depressed may be further performed. If this process is performed additionally, bonding force between the film 20 and the cup 22 can be further improved. Further, although it is shown in FIG. 3 that the cup 22 surrounds the film 20, the area of the film 20 may be formed greater than the plan area of the cup 22 such that the edges of the film 20 are curved and surround the cup 22.

As described above, in the fabrication of the zinc-air cell in accordance with the present invention, the film 20 is only stacked on the rectangle plate-shaped cup 22 having the downward depressed central portion, hereby realizing convenient and full sealing. Accordingly, the present invention can fabricate a zinc-air cell having a desired shape by solving the conventional problem in which a cell could be fabricated in a specific shape due to the difficulty of sealing.

Next, for the purpose of a chemical reaction in the film 20, the anode terminal 25 for supplying electrons is formed. The anode terminal 25 is formed by peeling off the hydrophobic membrane 310 at one end of the film 20, which will be used as the anode terminal, and exposing the metal mesh 320. The cathode terminal 24 and the anode terminal 25 can be drawn outside the casing (not shown) of a zinc-air cell to be formed later on.

As described above, the cathode terminal 24 and the anode terminal 25 are used as an electron migration path required for a chemical reaction in the anode and the cathode. Accordingly, the use of the anode can 18 and the cathode can 20 can be obviated, so that a zinc-air cell can be implemented as a desired shape, more specifically, a rectangular parallelepiped shape that is applicable to a cellular phone battery.

Although detailed embodiments of the present invention have been described, they are only illustrative. For example, in this specification, the zinc-air cell of the rectangular parallelepiped shape and the fabrication method of the cell have been disclosed. However, the shape of the cell is not limited to the above examples, and those having ordinary skill in the art can easily fabricate the cell of a desired shape by employing the present invention. Further, the materials of the respective constituent elements described in this specification can be easily selected from various known materials and replaced by those having ordinary skill in the art. Further, those having ordinary skill in the art may omit some of the constituent elements described in this specification without degrading performance or add a constituent element(s) in order to improve the performance. In addition, those having ordinary skill in the art may change the sequence of the method steps described in this specification according to process environment or equipment. Therefore, it is to be understood that the scope of the invention should be decided by the appended claims and equivalent arrangements not the embodiments.

1. A zinc-air cell, comprising:
a cup adapted to function as a sealant of the cell;
a film adapted to function as an anode of the cell and bonded on the cup, wherein the film has a first surface with a hydrophobic property and a second surface with ion permeability, and the second surface comes in contact with the cup; and a zinc gel adapted to function as a cathode of the cell and filled between the cup and the sealant.

2. The zinc-air cell of claim 1, further comprising:
a cathode terminal drawn from the zinc gel to the outside of the cell and transporting electrons, which are generated by a chemical reaction in the zinc gel; and
an anode terminal for supplying electrons from the outside to the film such that a chemical reaction can be generated in the film adapted to function as the anode.

3. The zinc-air cell of claim 1, wherein the first surface is formed of Teflon material, and the second surface is formed of polypropylene material.

4. The zinc-air cell of claim 1, wherein the cup is formed of polypropylene material.

5. The zinc-air cell of claim 1, wherein the cup is formed of the same material as that of the second surface of the film.

6. The zinc-air cell of claim 2, wherein the film has a multi-layered structure including a metal mesh, and the anode terminal is formed by removing a layer on a top of the metal mesh in one end of the film and exposing the metal mesh.

7. The zinc-air cell of claim 1, wherein the cathode terminal has a shape curved in an S shape or C shape.

8. A method of fabricating a zinc-air cell, comprising:
preparing a cup having a central portion of a downward depressed shape and functioning as a sealant of the cell;
bonding a film adapted to function as an anode of the cell on the cup, wherein the film has a first surface with a hydrophobic property and a second surface with ion permeability, and the second surface comes in contact with the cup; and filling a zinc gel, which functions as a cathode of the cell, in a space between the cup and the sealant.

9. The method of claim 8, further comprising:
inserting a cathode terminal for carrying electrons, which are generated in the zinc gel, into the zinc gel and drawing the cathode terminal outside the cell; and forming an anode terminal for supplying electrons to the film.

10. The method of claim 9, wherein:
the film has a multi-layered structure including a metal mesh, and
forming the anode terminal includes removing a layer on a top of the metal mesh in one end of the film and exposing the metal mesh.

11. The method of claim 8, wherein the bonding is performed using bonding employing heat fusion, ultrasonic fusion or a bonding agent.

12. The method of claim 8, further comprising curving edges of the cup in a shape that can surround the film so that the film is depressed in the edges of the cup.

13. The method of claim 8, wherein the cup is formed of the same material as that of the second surface of the film.

14. The method of claim 8, further comprising curving the cathode terminal in an S shape or C shape.
